(19) United States
(12) Patent Application Publication
(10) Pub. No.: US 2026/0091525 A1
(43) Pub. Date: Apr. 2, 2026

(54) ELECTRIC HAIR CUTTING DEVICE HAVING USER INPUT DEPENDENT SPEED CONTROL AND CHARGING STAND WITH GRAPHIC USER INTERFACE

(71) Applicant: WAHL CLIPPER CORPORATION, Sterling, IL (US)

(72) Inventors: Jason William WAGNER, Sterling, IL (US); Dhiraj BASNET, Dixon, IL (US)

(21) Appl. No.: 19/311,747

(22) Filed: Aug. 27, 2025

Related U.S. Application Data
(60) Provisional application No. 63/700,255, filed on Sep. 27, 2024.

(51) Int. Cl. B26B 19/38; B26B 19/06; B26B 19/28; H02J 7/00

(52) U.S. Cl. CPC B26B 19/388; B26B 19/06; B26B 19/28; B26B 19/3826; B26B 19/3886; H02J 7/42; H02J 7/731

(57) ABSTRACT

An electric hair cutting device including a housing having a first end and a second end opposite the first end, a bladeset mounted to the housing at the first end, the bladeset having a stationary blade and a reciprocating blade, an electric motor electrically connected to a power source within the housing, a drive shaft operatively connecting the electric motor to the reciprocating blade, a control module within the housing which controls a rotational speed of the electric motor; and a trigger which sends an actuation signal to the control module based on a partial actuation of the trigger between a minimum actuation and a maximum actuation, the control module adjusting a rotational speed of the electric motor based on the actuation signal. A related charging stand is provided that is compatible with the hair cutting device and features a digital display of device parameters.

### RELATED APPLICATION

The present application claims the benefit under 35 U.S.C. 119(e) of US Provisional Application No. 63/700,255 filed September 27, 2024, the entire contents of which are incorporated by reference herein.

### BACKGROUND

The present invention relates to electric hair cutting devices and charging stands, and more particularly to such an electric hair cutting device featuring user-initiated adjustable motor speed control and a charging stand with a graphic user interface for charging the electric hair cutting devices.

Electric hair cutting devices such as shavers, or hair clippers and trimmers (the latter two being used interchangeably herein), are common tools for both professional hairstylists and barbers, as well as for personal grooming at home or for grooming animals. These devices typically include an electric motor that drives the cutting blades to trim or cut hair. The performance of an electric hair cutting device is highly dependent on the speed of its electric motor, which directly controls the movement of a moving cutting blade, and thus influences the cutting efficiency, the quality of the haircut, and the user's overall experience.

Such devices often have a single or limited number of motor speed settings, which often is not suitable for all hair types, cutting techniques, or user preferences. For example, best results for cutting certain hair types, such as thick or coarse hair, involve a higher motor speed for effective cutting, while other hair types, such as fine or thin hair, involve a lower motor speed for better control and precision. Additionally, professional hairstylists and barbers often prefer multiple motor speeds to accommodate various cutting techniques and styles. However, conventional electric hair cutting devices have a limited capability for motor speed adjustment.

Professional hair stylists and barbers typically associate different motor speeds of the hair clipper as being appropriate for cutting particular types of hair, such as using lower motor speeds for thin or fine hair.

Additionally, operating electric hair cutting devices at a faster speed typically results in increased heat, vibration, and noise being generated by the electric motor, and may result in faster wear of the internal components. Regarding battery-powered hair clippers, operating the hair clipper at faster speeds drains the battery within the hair clipper more quickly.

Some attempts have been made to address this issue, such as providing hair clippers with multiple discrete speed settings. However, these solutions often add complexity to the device, increase manufacturing costs, and often do not offer the desired range, or precise control, of motor speeds for all users. Further, with discrete speed settings, many barbers and stylists may need to halt a current cutting pass to carefully change the speed of the motor using a switch, dial, etc., of the device before returning to that cutting pass, which can lead to blending line visibility problems or inaccuracies.

Accordingly, there is a need in the art for an improved electric hair cutting device and corresponding charging stand with a graphic user interface that address the above challenges and needs in the current state of the art.

### SUMMARY

The above-listed need is met or exceeded by the present electric hair cutting device having on demand user input variable speed control and corresponding charging stand with a graphic user interface. Specifically, the present electric hair cutting device, in the form of a hair trimmer, includes a trigger which is partially actuated between a minimum actuation and a maximum actuation of the trigger. Based on this partial actuation, the trigger sends an actuation signal to a control module of the hair trimmer, which in turn sends a control signal to the electric motor to increase a rotational speed of an eccentric cam-equipped drive shaft of the electric motor. In an embodiment, increased pressure applied by the user results in increased trimmer motor speed.

In an embodiment, the electric motor has a base rotational speed associated with the hair clipper being turned on, and the partial actuation of the trigger increases the rotational speed of the electric motor beyond the base rotational speed. The user optionally controls the amount by which the rotational speed of the motor is increased by controlling the partial actuation of the trigger. Accordingly, the user is able to increase the speed of the electric motor precisely and for a limited duration as needed while cutting hair. This helps reduce power consumption of the battery, heat generation by the electric motor, vibration, and wear of the hair trimmer.

The trigger allows for any partial actuation in the continuous range of actuations between the minimum actuation and the maximum actuation. This provides additional flexibility to the user, as the user is not limited to discrete speed settings of the electric motor. Additionally, the trigger is located on a back half of a housing for the hair trimmer, in close proximity to a natural resting place of an index finger of the user. This helps improve the ergonomics of the hair trimmer and ease with which the user actuates the trigger. Further, an on-off switch of the hair trimmer is located on a front half of the housing of the hair trimmer, such that the two operative controls of the hair trimmer are on opposite sides of the hair trimmer.

The corresponding charging stand for the present electric hair cutting device includes a display screen with a real-time display of an operational parameter of the electric hair cutting device. A control module of the charging stand includes a wireless communication interface which allows communication between the electric hair cutting device and the charging stand, such that the electric hair cutting device relays information pertaining to the operational parameter to the charging stand.

In one example, where the operational parameter is the rotational speed of the electric motor within the electric hair cutting device, the real-time rotational speed of the electric motor is determined by monitoring a current supplied to the electric motor and using measured current to calculate an instantaneous motor speed. Once the operational parameter is determined, either by the user or the charging stand, the operational parameter is displayed on a digital display of the charging stand. Thus, the user of the charging stand and electric hair cutting device is able to conveniently associate a specific rotational speed of the electric motor to different hair types, different hair areas on the head, etc. For example, a user is able to associate a particular rotational speed (e.g. 6750 rpm) as advantageous for cutting African American hair, but not Caucasian hair.

Additionally, the user is able to associate a particular activation of the trigger to a specific rotational speed of the electric motor, by viewing the measured rotational speed of the electric motor which is displayed on the digital display of the charging stand. Moreover, the charging stand advantageously includes an insert which allows various electric hair trimmers to optionally fit within a charging port of the charging stand. Additional customization features are also optionally available, as the user is able to adjust the charger display, by for example, setting the wallpaper of the digital display, the color for a string of LED lights proximate to a bottom surface of the charging stand, and/or the particular electric hair cutting device being paired with the charging stand.

More specifically, an electric hair cutting device is provided, including a housing having a first end and a second end opposite the first end, a bladeset mounted to the housing at the first end, the bladeset having a stationary blade and a reciprocating blade, an electric motor electrically connected to a power source within the housing, a drive shaft operatively connecting the electric motor to the reciprocating blade, a control module within the housing which controls a rotational speed of the electric motor, and a trigger which sends an actuation signal to the control module based on a partial actuation of the trigger between a minimum actuation and a maximum actuation, the control module adjusting a rotational speed of the electric motor based on the actuation signal.

In an embodiment, the electric hair cutting device includes an on-off switch distinct from the trigger, such that activation of the on-off switch to an on-position causes the electric motor to rotate at a base rotational speed. The partial actuation of the trigger causes the electric motor to rotate at a rotational speed above the base rotational speed. The trigger allows for the partial actuation to be any actuation in a continuous range of actuations between the minimum actuation and the maximum actuation.

In another embodiment, the trigger is a mechanical trigger which is actuated between the minimum actuation and the maximum actuation based on an amount of pressure applied to the mechanical trigger. The mechanical trigger includes a force resistive sensor, and the force resistive sensor is disposed in a voltage divider circuit, such that the actuation signal corresponds to an output voltage from the force resistance sensor. In yet another embodiment, the mechanical trigger includes a push button connected to a pressure sensor, such that the actuation signal corresponds to a pressure value applied to the push button.

In yet another embodiment, the trigger is an optical sensor which is actuated between the minimum actuation and the maximum actuation by adjusting an amount of light received by the optical sensor.

In a further embodiment, the trigger is disposed on a back face of the housing in a location proximate to an index finger of a user of the electric hair cutting device. The electric hair cutting device includes a lock which causes the trigger to remain in a particular actuation between the minimum actuation and the maximum actuation, and a safety which prevents actuation of the trigger.

A second embodiment includes a charging stand for an electric hair cutting device which has a casing with a top surface having a charging port for the electric hair cutting device, a front surface with a digital display; and a control module within the casing which is connected to the digital display and which includes a wireless communication interface. In operation, the wireless communication interface receives control signals from the electric hair cutting device and the control module causes the digital display to display, in real-time, at least one operational parameter of the electric hair cutting device received by the wireless communication interface.

In an embodiment, the operational parameter of the electric hair cutting device is a rotational speed of an electric motor housed within the electric hair cutting device. Advantageously, the charging port includes an insert which is removably secured within the top surface, and the digital display includes a settings page with buttons which direct the digital display to a plurality of subpages which control various aspects of the charging stand.

In another embodiment, the buttons of the settings page include an LED light changing page which allows adjustment of a color displayed by a string of LED lights disposed on the casing. Advantageously, the wireless communication interface is a Bluetooth receiver, and the electric hair cutting device is Bluetooth compatible, such that the buttons of the settings page include a Bluetooth pairing page which is configured to providing pairing of the electric hair cutting device to the charging stand.

In yet further embodiments, the casing includes an auxiliary charging port configured for charging a separate electronic device and the digital display displays at least one wallpaper from a plurality of wallpapers, and the at least one wallpaper displayed includes the operational parameter.

### BRIEF DESCRIPTION OF THE DRAWINGS

FIG. 1 is a front perspective view the present electric hair cutting device;

FIG. 2 is a partially exploded front perspective view of the electric hair cutting device of FIG. 1;

FIG. 3 is a vertical cross-section view of the electric hair cutting device of FIG. 1;

FIG. 4 is a schematic diagram illustrating a control module and a trigger of the electric hair cutting device of FIG. 1;

FIG. 5 is a graphic representative of test data where voltage of a pressure sensor within the electric hair cutting device of FIG. 1 at various weights applied to the pressure sensor was compared;

FIG. 6 is a graphic representative of test data where rotational speed of an electric motor within the electric hair cutting device of FIG. 1 at various voltages of the pressure sensor was compared;

FIG. 7 is a front perspective view the present electric hair cutting device of FIG. 1 disposed upon the present charging stand with graphical user interface;

FIG. 8 is a front perspective view of the charging stand of FIG. 7;

FIG. 9 is a rear perspective view of the charging stand of FIG. 7;

FIG. 10 is a schematic diagram illustrating a control module of the charging stand of FIG. 7;

FIG. 11 is a front plan view of a first example wallpaper for the graphical user interface of the charging stand of FIG. 7;

FIG. 12 is a front plan view of a second example wallpaper for the graphical user interface of the charging stand of FIG. 7;

FIG. 13 is a plan view of a settings page for the graphical user interface of the charging stand of FIG. 7;

FIG. 14 is a plan view of a Bluetooth pairing page for the graphical user interface of the charging stand of FIG. 7;

FIG. 15 is a plan view of a LED light changing page for the graphical user interface of the charging stand of FIG. 7;

FIG. 16 is a plan view of a wallpaper page for the graphical user interface of the charging stand of FIG. 7; and

FIG. 17 is an exploded front perspective view of the charging stand of FIG. 7.

### DETAILED DESCRIPTION

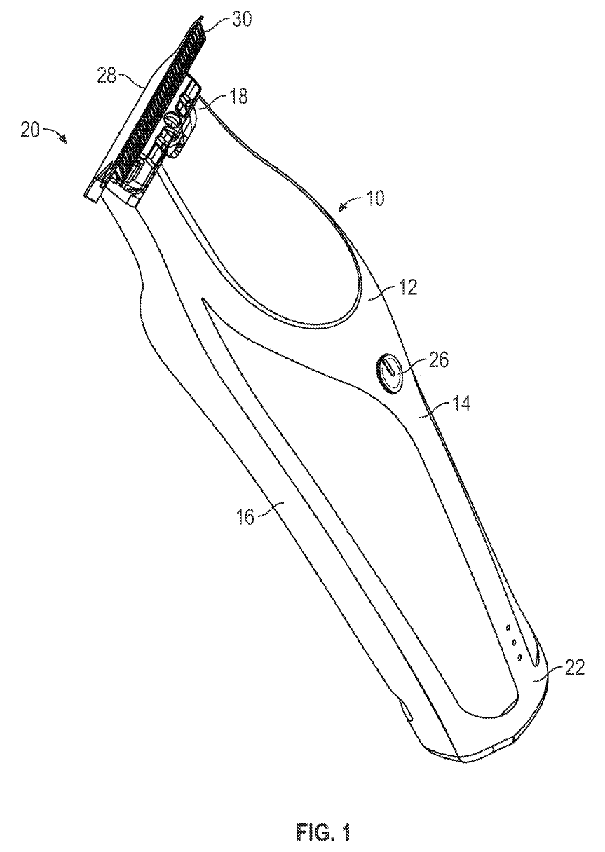

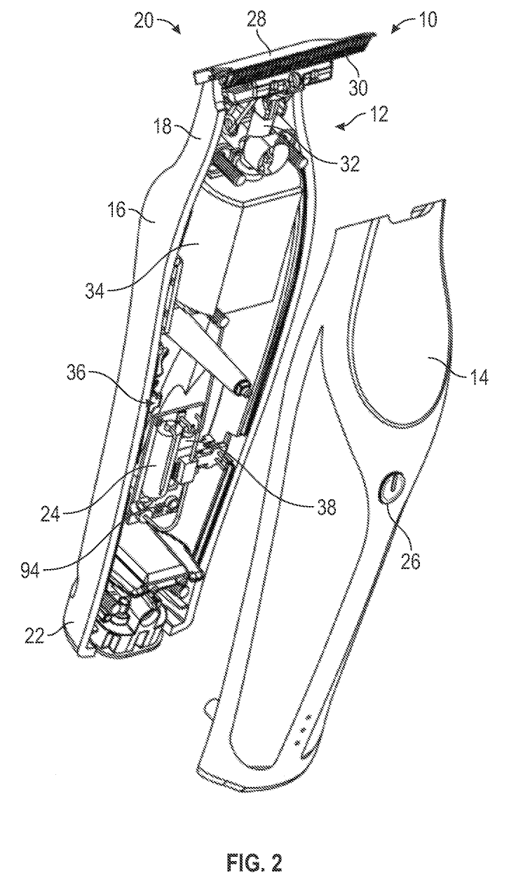

Referring now to FIGS. 1-3, in which the components are shown schematically and not to scale, an electric hair cutting device is generally designated 10 and is in the form of a hair trimmer. The hair trimmer 10 includes a housing, generally designated 12 incorporating a front housing half 14 and a back housing half 16. This depiction of hair trimmer 10 is exemplary only, as the present disclosure optionally relates to any electric hair cutting device having an electric motor to achieve the benefits herein.

Included on the housing 12 is a drive or working end 18, to which is mounted a bladeset 20, and an opposite rear end 22, configured for accommodating a charging cord for recharging an internal battery 24. It is also contemplated that the present hair trimmer 10 is alternately powered by wall voltage supplied by a traditional power cord or by placing the hair trimmer on a charging stand. A power switch 26 on the front housing half 14 is used to turn the hair trimmer 10 on and off.

The bladeset 20 includes a stationary blade 28 and a laterally reciprocating moving blade 30 driven by an eccentric cam-equipped drive shaft 32 of an electric motor 34. A control module 36, advantageously in the form of a circuit board 38, controls the operation of the electric motor 34, and receives power from the internal battery 24.

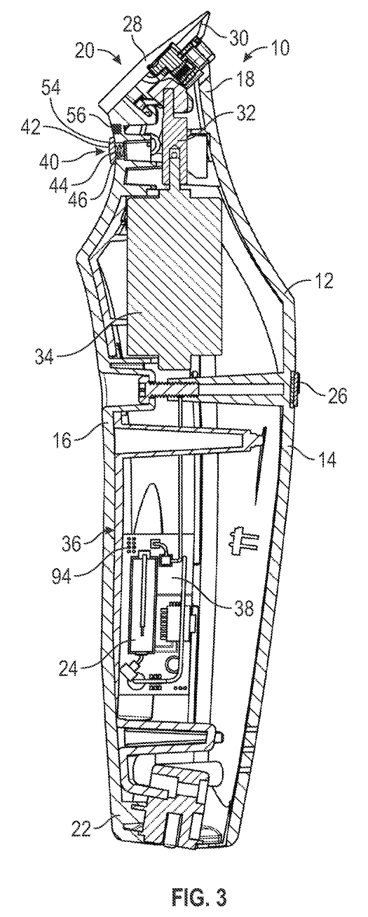

Referring now to FIG. 3, the back housing half 16 includes a trigger 40 which sends an actuation signal to the control module 36, and the control module uses the actuation signal to adjust the rotational speed of the electric motor 34, as discussed in greater detail below. The term “trigger” as used herein includes any type of user input expedient, including but not limited to mechanical devices, buttons, switches, sliders, pressure sensing devices, temperature sensing devices, light sensing devices, touch sensitive devices, microphones and related componentry for voice control, or any other device capable of receiving a user input. The trigger 40 is disposed at a location on the back housing half 16 in close proximity to a natural resting position of an index finger of a user of the hair trimmer 10, improving the ergonomics of the hair trimmer and ease with which the user actuates the trigger 40. Additionally, the trigger 40 is disposed on an opposite side of the hair trimmer 10 compared to the power switch 26 in the illustrated embodiment. It is envisioned, however, that the trigger 40 may be situated anywhere on the hair trimmer that is accessible to the user.

In an example embodiment, the trigger 40 takes the form of a push button 42 biased by a compression spring 44 away from the back housing half 16. Additionally, the trigger 40 includes a pressure sensor 46 which measures the pressure applied to the push button 42 and sends the actuation signal to the control module 36 based on the measured pressure. When the trigger 40 includes the push button 42, a minimum actuation of the trigger corresponds to a user applying zero pressure to the push button, while a maximum actuation of the trigger corresponds to the user compressing the push button to a maximum compression allowed by the compression spring 44.

The trigger 40 allows for partial actuation between the minimum and maximum actuation of the trigger. For example, when the user compresses the push button 42 by applying a pressure which compresses the compression spring 44 by 27% of the maximum allowed pressure, the pressure sensor 46 measures the pressure exerted on the push button corresponding to the 27% actuation and sends the actuation signal to the control module 36. The trigger 40 is optionally actuated at any percentage between the minimum actuation and the maximum actuation, and the actuation signal optionally corresponds the percentage by which the user actuated the trigger. In other words, the trigger 40 allows for any partial actuation in the continuous range of actuations between the minimum actuation and the maximum actuation.

The control module 36 operatively controls the speed at which the moving blade 30 laterally reciprocates relative to the stationary blade 28. In an embodiment, when the user turns on the hair trimmer 10 by pressing the power switch 26, the control module 36 sends a base control signal to the electric motor 34 which causes the electric motor to drive the moving blade 30 at a base speed. For example, in one embodiment, the base speed corresponds to a rotational speed of the eccentric cam-equipped drive shaft 32 of 6000 revolutions per minute (RPM). The base speed corresponds to the minimum actuation of the trigger 40, when the trigger is not actuated.

After receiving the actuation signal, the control module 36 sends a control signal to the electric motor 34 to adjust the rotational speed of the eccentric cam-equipped drive shaft 32 above the base speed. Specifically, as the partial actuation applied to the trigger 40 increases, the rotational speed of the eccentric cam-equipped drive shaft 32 also increases, until the trigger reaches the maximum actuation, where the eccentric cam-equipped drive shaft hits the maximum speed. In an embodiment, as the electric motor 34 increases in speed above the base speed, the noise created by the electric motor also increases, providing audible confirmation to the user that the rotational speed of the electric motor has increased. Advantageously, the increase in noise from the electric motor 34 is roughly proportionally to the increase in actuation of the trigger 40. In this way, the user is able to gauge the sensitivity of the trigger 40 based on the increase in noise from the electric motor 34 with a given partial actuation.

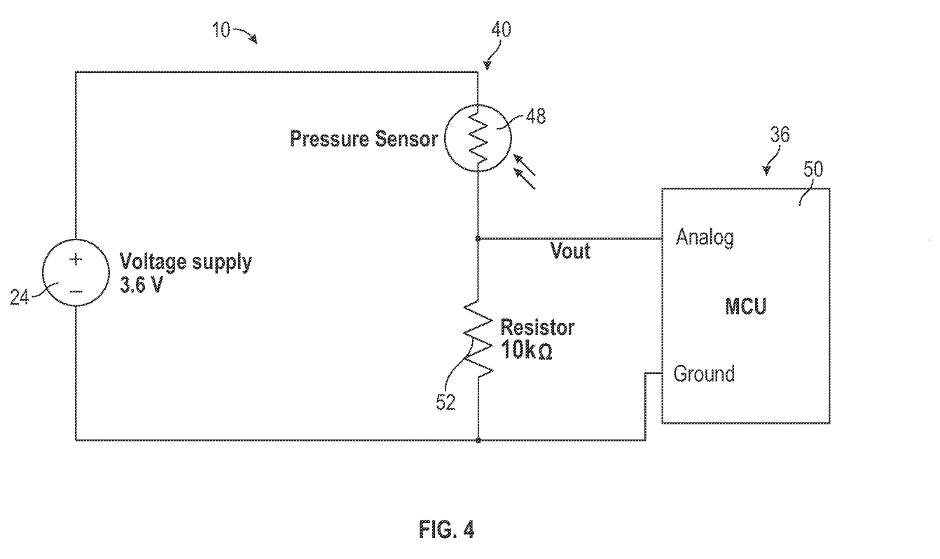

FIG. 4 illustrates a schematic diagram of components within an example embodiment of the hair trimmer 10, where the trigger 40 takes the form of a force resistive sensor 48, such as a strain gauge. The force resistive sensor 48 sends the actuation signal to the control module 36, which is shown as a micro-control unit 50. In the embodiment of FIG. 4, the force resistive sensor 48 is provided in a voltage divider circuit, where a resistor 52 is placed in series with the force resistive sensor. The actuation signal sent from the force resistive sensor 48 to the micro-control unit 50 is a voltage output from the force resistive sensor. Specifically, the force resistive sensor 48 has a large resistance value when no pressure is applied to the force resistive sensor, or when the force resistive sensor is at the minimum actuation. Accordingly, the voltage output from the force resistive sensor 48 is nominal when at the minimum actuation. However, as the force resistive sensor 48 is actuated between the minimum actuation and the maximum actuation, the resistance value of the force resistive sensor decreases, resulting in an increased output voltage being registered by the micro-control unit 50.

As the output voltage received by the micro-control unit 50 increases, the micro-control unit sends the control signal to the electric motor 34 to increase the driving speed of the eccentric cam-equipped drive shaft 32. Similarly, as the voltage value received by the micro-control unit 50 decreases, corresponding to a decrease in the partial actuation of the force resistive sensor 48, the micro-control unit sends a control signal to the electric motor 34 to decrease the driving speed of the eccentric cam-equipped drive shaft 32.

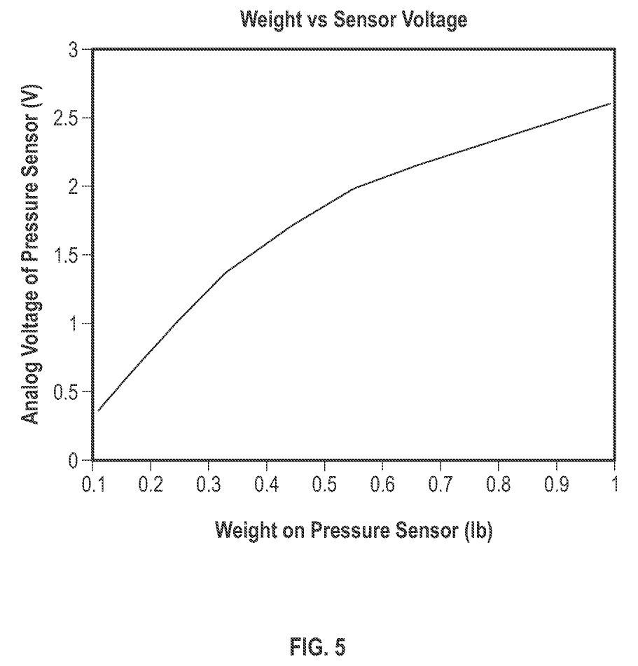

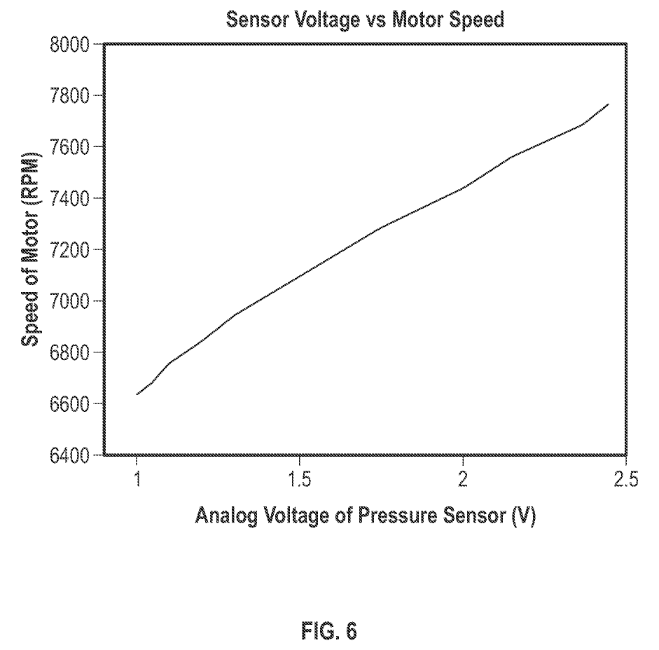

FIG. 5 is a graph which plots the voltage output of the force resistive sensor 48 compared to the weight applied to the force resistive sensor. As shown in FIG. 5, as the weight on the force resistive sensor 48 increases, the output voltage to the micro-control unit 50 also increases. Likewise, FIG. 6 is a graph which plots the output voltage from the force resistive sensor 48 compared to the rotational speed of the electric motor 34. As the output voltage from the force restive sensor 48 increases, the rotational speed of the electric motor 34 also increases.

While FIGS. 3-4 show the trigger 40 as being either the push button 42 or the force resistive sensor 48, as mentioned above, alternate devices, such as a slider, an optical sensor, a temperature sensor, or other similar electronic or mechanical user interfaces may be optionally used as the trigger. For example, when the trigger 40 is an optical sensor, the partial actuation between the minimum actuation and the maximum actuation is adjusted based on an amount of light received by the optical sensor.

Additionally, in certain embodiments, the hair trimmer 10 includes a lock 54 which allows the user to set a particular partial actuation of the trigger 40. Further, a mechanism 56 may be included which locks the trigger 40 in the minimum partial actuation, so that the electric motor 34 is prevented from increasing in speed above the base minimum speed.

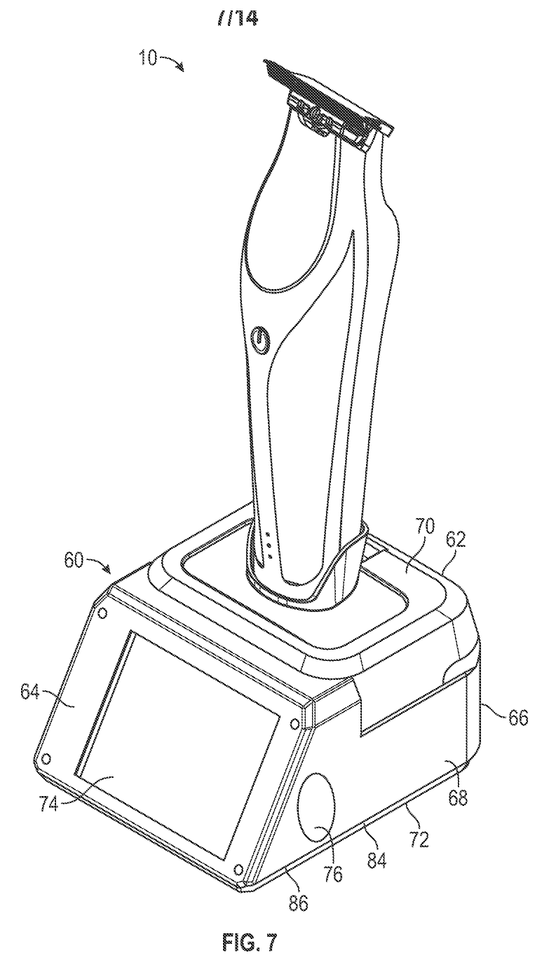

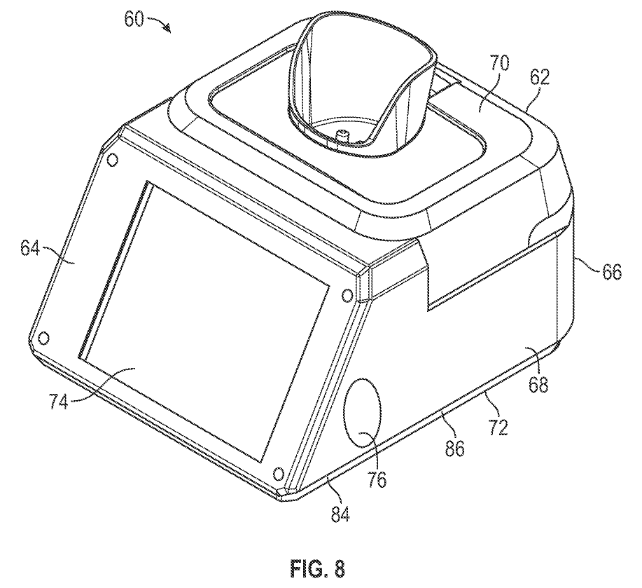

Referring now to FIGS. 7 and 8, in which the components are shown schematically and not to scale, a charging stand with graphical user interface is generally designated 60 and is illustrated in conjunction with the hair trimmer 10. As shown in FIGS. 7 and 8, the charging stand 60 includes a casing 62 with a front face 64, a rear face 66, side walls 68, a top surface 70, and a bottom surface 72. Advantageously, a more user-friendly arrangement is obtained by slanting the front face 64 at an acute angle with respect to a bottom surface 68 of the casing 62. Additionally, the front face 64 includes a digital display 74, which is advantageously an LCD touch screen. In an embodiment, at least one of the side walls 68 includes an auxiliary charging port 76 which is optionally used to charge a separate device (not shown), such as a cell phone, a hair dryer, etc. The auxiliary charging port 76 is optionally a USB port, a micro-USB port, a lightning port, a standard outlet, or other appliance charging port formats known in the art.

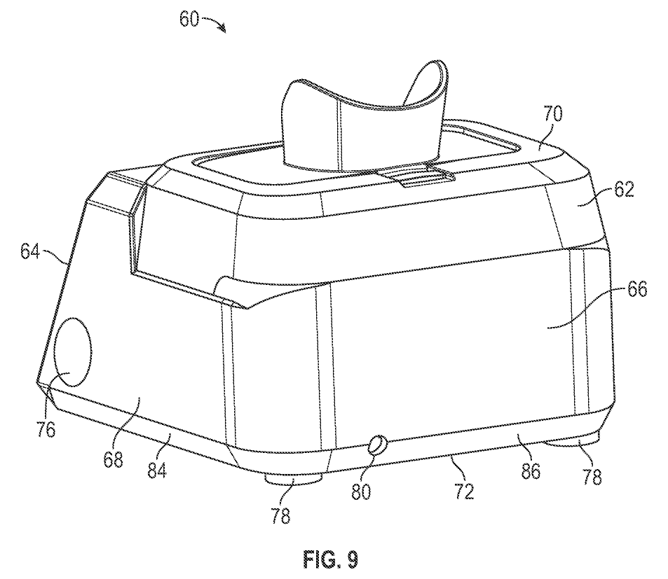

Referring now to FIG. 9, the bottom surface 72 advantageously includes feet 78 which are made of are made of a suitable resilient material, such as rubber, which provides sufficient traction to hold the charging stand 60 stationary when in use on a table or stylist workstation. Moreover, the rear face 66 of the casing 62 advantageously includes a main charging port 80 for charging an internal battery 82 of the charging stand 60. It is contemplated that the location of the charging ports 76 and 80 may vary depending on the application.

An edge 84, which is advantageously chamfered, forms an interface between the side walls 68 and the bottom surface 72, as well as an interface between the rear face 66 and the bottom surface. In an embodiment, the edge 84 includes a string of LED lights 86 which is electrically coupled to a charging stand control module 88. It is contemplated that the location of the string of LED lights 86 on the charging stand 60 may vary by application.

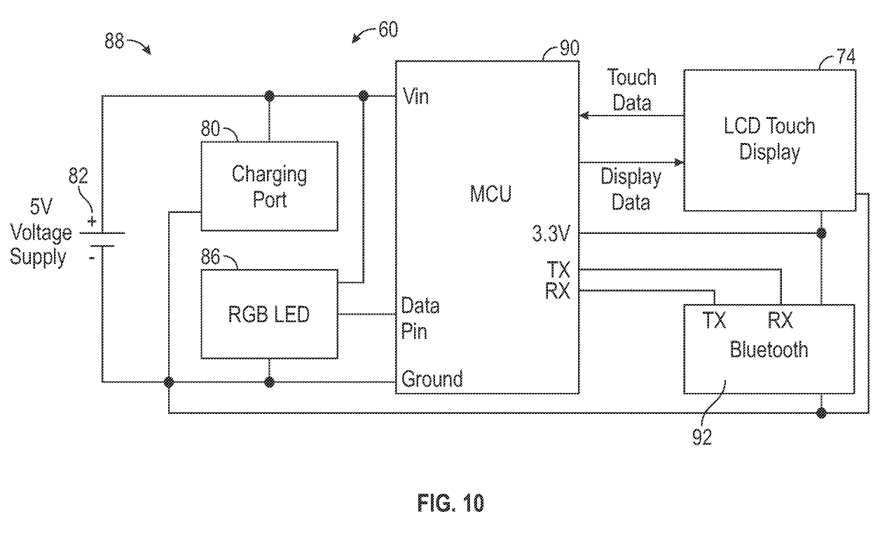

FIG. 10 shows a schematic diagram illustrating the control module 88 within the casing 62 of the charging stand 60. As with the hair trimmer 10, the control module 88, which also is advantageously in the form of a circuit board, includes a micro-control unit 90, which controls the operation of the charging stand 60, and receives power from the internal battery 82. The charging stand 60 also includes a wireless communication module 92 which communicates with a corresponding wireless communication transmitter 94 of the hair trimmer 10. In an embodiment, the charging stand 60 and the hair trimmer 10 have a master-slave relationship, where the hair trimmer relays information to the charging stand, which in turn adjusts a display on the digital display 74. In the embodiment of FIG. 10, the wireless communication module 92 is a Bluetooth device which pairs with Bluetooth compatible hair trimmers 10. However, different wireless communication devices are contemplated for use as the wireless communication module 92.

The wireless communication module 92 relays information received from the wireless communication transmitter 94 of the hair trimmer 10 to the control module 88. The information transmitted from the hair trimmer 10 to the charging stand 60 includes at least one operational parameter of the hair trimmer, which is described in greater below. In the embodiment of FIG. 10, where the digital display 74 is an LCD touch display, the digital display relays touch data from the user to the control module 88 and receives display commands from the control module 88 based on information received from the wireless communication module 92. Further, the string of LED lights 86, when present, receives a control signal from the control module 88 to change at least one of the brightness, flashing sequence and the color shown by the LED lights.

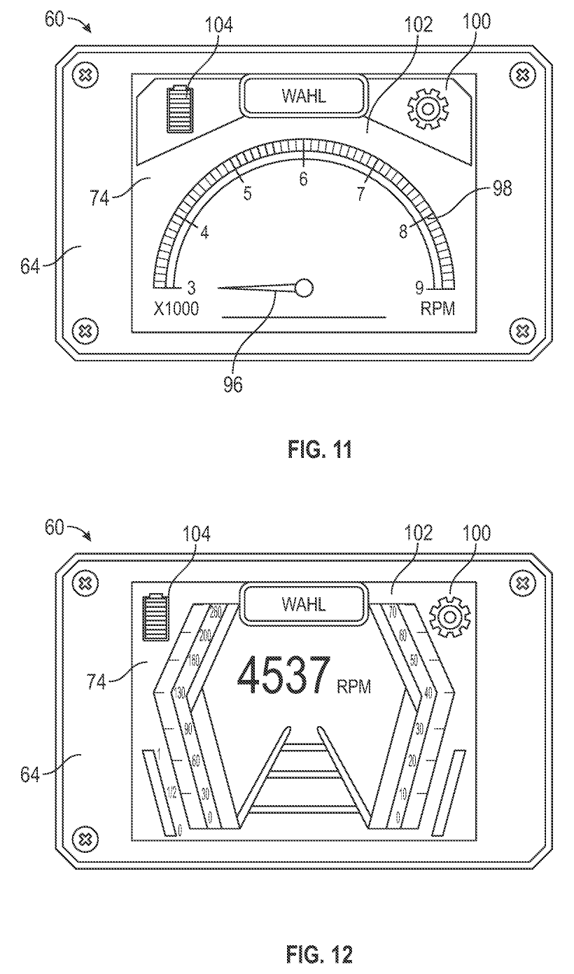

Referring now to FIGS. 11 and 12, an example operational parameter which is relayed from the hair trimmer 10 to the charging stand 60 is the rotational speed of the electric motor 34. Specifically, when the user of the hair trimmer 10 activates the trigger 40, resulting in the electric motor 34 having a particular rotational speed, the wireless communication transmitter 94 relays the rotational speed of the electric motor to the wireless communication module 92, which in turn displays the rotational speed on the digital display 74. As a result, the digital display 74 of the charging stand 60 displays in real-time the operational parameter of the hair clipper 10, which in the case of FIGS. 11 and 12 is the rotational speed of the electric motor 34.

In other words, the charging stand 60 provides a digital readout of a current rotational speed of the electric motor 34. Thus, when the user of the hair clipper 10 throttles the trigger 40 to increase or decrease the rotational speed of the electric motor 34, the digital display 74 changes accordingly, by at least one of numerical display, brightness, color or flashing sequence. In the example of FIG. 11, when the trigger 40 is activated, a needle 96 of a speedometer 98 on the digital display 74 moves to match the rotational speed of the electric motor 34. Accordingly, the user of the hair clipper 10 is able to associate a specific operational parameter of the hair clipper with different hair types, different hair areas on the head, etc. When the rotational speed of the electric motor 34 is the operational parameter, the user of the hair clipper 10 is able to correlate a specific rotational speed of the electric motor (e.g. 6750 rpm) as being ideal for particular types and styles of hair and not others. Referring to FIG. 12, the digital display 74 is displaying a numerical read-out which matches the rotational speed of the electric motor 34.

As noted above, the digital display 74 shows the at least one operational parameter of the hair clipper 10. Various parameters are optionally considered as being the at least one operational parameter. For example, with regard to the moving blade 30, a non-limiting list of operational parameters advantageously includes a temperature of the moving blade, a remaining life of the moving blade, a blade type of the moving blade, a blade offset of the moving blade (such 0.1mm offset, 0.2mm offset, etc.), and a taper lever setting of the moving blade.

Moreover, with regard to the internal battery 24 of the hair clipper 10, a non-limiting list of operational parameters advantageously includes the remaining voltage or current of the internal battery, the remaining available runtime of the internal battery, the temperature of the internal battery, the amount of time until a full charge of the internal battery, the charge cycles of the internal battery, and the battery health of the internal battery.

Regarding the electric motor 34, a non-limiting list of operational parameters advantageously includes the rotational speed of the electric motor, the current supplied to the electric motor, the voltage supplied to the electric motor, the temperature of the electric motor, the locked rotational speed at which the lock 54 is set to hold the trigger 40 at a partial actuation, a rotational speed setting of the electric motor (e.g. High/Medium/Low) which is displayed in conjunction with the actual rotational speed, and the adjustable torque of the electric motor.

Additional non-limiting examples of operational parameters advantageously includes the real time with day, month, and year, the operational run time of the hair clipper 10 in a particular quantity of time, the number of haircuts per a particular quantity of time, a hairstyle database which allows the user of the charging stand 60 to save potential hair styles of individual customers, a maintenance indicator which provides maintenance suggestions for the hair clipper, such as when to change the oil or replace the internal battery, a cutting efficiency of the hair clipper (e.g. the amount of time that the hair clipper is cutting hair versus the amount of time the hair clipper is not cutting hair), the number of cuts or swipes of the hair clipper, the on-off cycles of the hair clipper, an ability to receive direct communications for replacement blade offers or subscription offers, rewards for the number of hours the hair clipper is used, leaderboards or ranks compared to a user community, an estimated number of haircuts performed with the hair clipper, a username or profile for a user of the hair clipper, product or accessory recommendations based on usage patterns of the hair clipper, a digital lock-unlock switch which locks the hair clipper, thereby preventing operation of the hair clipper, instruction books for use of the hair clipper, software updates, user tips based on usage patterns of the hair clipper, educational content, and custom displays, wallpapers and dashboards for the digital display 74.

Moreover, electric hair trimmer 10 and the charging stand 60 optionally include sensors used to measure the at least one operational parameter of the hair clipper 10. For example, when the at least one operational parameter is the temperature of the moving blade 30, the hair trimmer includes a temperature sensor (not shown) which measures the temperature of the moving blade. Further, the control module 88 of the charging stand 60 performs the relevant calculations to determine the at least one operational parameter, when appropriate.

In reference to FIGS. 11 and 12, the digital display 74 optionally takes various forms, which are advantageously selected by a user of the charging stand. For example, the digital display 74 advantageously includes a menu button 100 which allows the user to adjust various features of the digital display, including the wallpaper 102 of the digital display. The digital display 74 advantageously includes a battery icon 104 which allows the user to view a battery screen which displays information about the current state of the internal battery 82 and/or the clipper battery 24, such as the battery percentage, the available run time, the time to full charge, the charging rate, etc.

In particular, FIG. 11 shows an example wallpaper 102 which includes the speedometer 98 to show the at least one operational parameter of the hair trimmer 10. FIG. 12 shows an alternate wallpaper 102 which provides a readout of the at least one operational parameter. It is appreciated that various wallpapers are optionally used on the digital display 74.

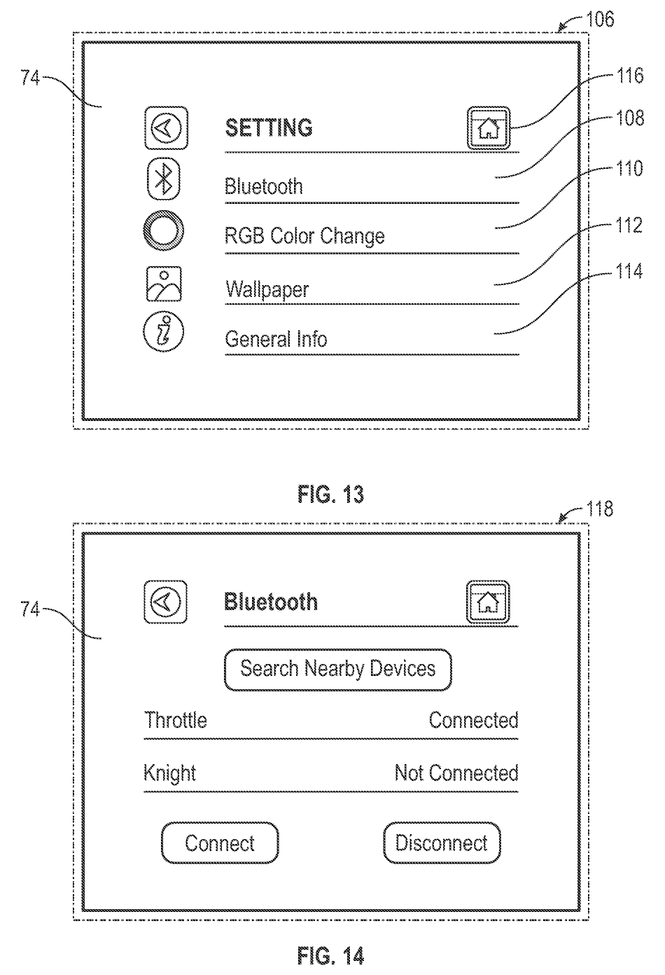

FIG. 13 shows the digital display 74 after the user activated the menu button 100 of FIGS. 11 and 12. In the embodiment of FIG. 13, the menu button 102 directs the digital display to a settings page 106 which optionally has a Bluetooth pairing button 108, a LED light changing button 110, a wallpaper changing button 112, and a general information button 114, and a home button 116. As shown in FIG. 14, the Bluetooth pairing button 108 directs the user to a Bluetooth pairing page 118 which allows the user to search for, connect to, and disconnect available hair trimmers 10 with Bluetooth capabilities. Advantageously, the Bluetooth capable hair trimmers 10 are listed on the Bluetooth pairing page 118.

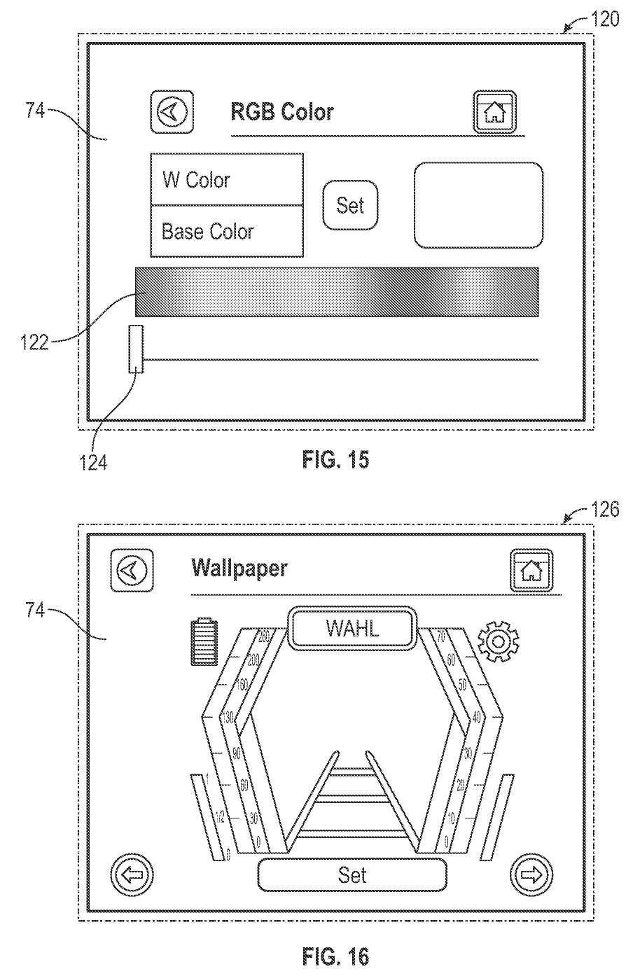

Illustrated in FIG. 15 is an LED light changing page 120 which is displayed on the digital display 74 when the user activates the LED light changing button 110. Specifically, the light changing page 120 advantageously includes a color bar 122 and a slider 124 which allows a user to set a color for the string of LED lights 86. The user optionally sets a color for a “W” located on one of the side walls 68 of the casing 62.

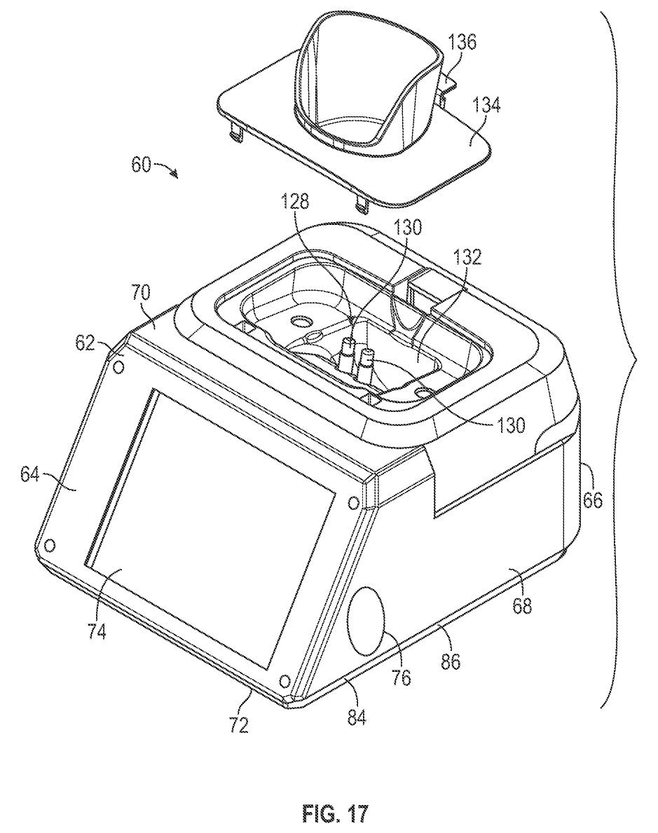

In the embodiment of FIG. 11, where the wallpaper includes the speedometer 98, the color associated with the RPM value advantageously changes between 3000 RPM and 9000 RPM. For example, the speedometer 98 optionally transitions between blue, green, yellow, orange, and red at equal intervals between 3000 RPM and 9000 RPM. In this embodiment, the LED light changing page 120 advantageously allows the user to set the color of the string of LED lights 86 to match the color of the speedometer for the RPM value of the electric motor 34. Further, illustrated in FIG. 17 is a wallpaper page 126 which allows the user to set the wallpaper to be displayed on the digital display 74.

Referring now to FIG. 17, the top face 70 of the casing 62 includes a charging port 128 with charging pins 130 extending out of a charging cavity 132. The charging cavity 132 receives a corresponding insert 134 which is designed to receive and accommodate by shape a particular hair trimmer 10. For example, the insert 134 is optionally designed to match an electric hair clipper, an electric hair trimmer, an electric shaver, etc. In an embodiment, the insert 134 is removably secured within the charging port 128, such as by a snap fitting clip 136. As such, various inserts 134 are optionally used in conjunction with the charging stand 60.

The systems and devices described above optionally include a control module or a computing device comprising a processing and a memory having stored computer-executable instructions for implementing the above-described processes described. The processing unit optionally includes any suitable devices configured to cause a series of steps to be performed so as to implement the method such that instructions, when executed by the computing device or other programmable apparatus, optionally causes the functions/acts/steps specified in the methods described above to be executed. The processing unit optionally includes, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory optionally is any suitable known or other machine-readable storage medium. The memory optionally includes non-transitory computer readable storage medium such as, for example, but not limited to, an electronic, magnetic, optical, electromagnetic, infrared, or semiconductor system, apparatus, or device, or any suitable combination of the foregoing. The memory optionally includes a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory also contemplates any storage configuration (e.g., devices) suitable for retrievably storing the computer-executable instructions executable by processing unit.

The methods and systems described above is optionally implemented in a high-level procedural or object-oriented programming or scripting language, or a combination thereof, to communicate with or assist in the operation of the control module or computing device. Alternatively, the methods and systems described above are optionally implemented in assembly or machine language. The language is optionally a compiled or interpreted language. Program code for implementing the methods and systems described here are optionally stored on the storage media or the device, for example a ROM, a magnetic disk, an optical disc, a flash drive, or any other suitable storage media or device. The program code is optionally readable by a general or special-purpose programmable computer for configuring and operating the computer when the storage media or device is read by the computer to perform the procedures described above.

Computer-executable instructions are optionally in many forms, including modules, executed by one or more computers or other devices. Generally, modules include routines, programs, objects, components, data structures, etc., that perform particular tasks or implement particular abstract data types. Typically, the functionality of the modules are optionally combined or distributed as desired in various embodiments.

While a particular embodiment of the electric hair cutting device having user input dependent speed control and corresponding charging stand with a graphic user interface has been described herein, it will be appreciated by those skilled in the art that changes and modifications may be made thereto without departing from the invention in its broader aspects and as set forth in the following claims.

All references, including publications, patent applications, and patents cited herein are hereby incorporated by reference to the same extent as if each reference were individually and specifically indicated to be incorporated by reference and were set forth in its entirety herein.

The term “electric hair cutting device” as used herein includes any electric hair cutting device that includes a motor which drives a moving blade to cut hair, including but not limited to hair clippers, hair trimmers, and electric shavers. The terms “hair clipper” and “hair trimmer” are used interchangeably unless otherwise noted, and do not limit the scope or applicability of the invention herein to either particular variant.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electric hair cutting device, comprising:
a housing having a first end and a second end opposite said first end;
a bladeset mounted to said housing at said first end, said bladeset comprising a stationary blade and a reciprocating blade;
an electric motor electrically connected to a power source within said housing;
a drive shaft operatively connecting said electric motor to said reciprocating blade;
a control module within said housing which controls a rotational speed of said electric motor; and
a trigger which sends an actuation signal to said control module based on a partial actuation of said trigger between a minimum actuation and a maximum actuation, said control module adjusting a rotational speed of said electric motor based on said actuation signal.

2. The electric hair cutting device of claim 1, further comprising an on-off switch distinct from said trigger, such that activation of said on-off switch to an on-position causes said electric motor to rotate at a base rotational speed.

3. The electric hair cutting device of claim 2, wherein said partial actuation of said trigger causes said electric motor to rotate at a rotational speed above the base rotational speed.

4. The electric hair cutting device of claim 1, wherein said trigger allows for said partial actuation to be any actuation in a continuous range of actuations between said minimum actuation and said maximum actuation.

5. The electric hair cutting device of claim 1, wherein said trigger is a mechanical trigger which is actuated between said minimum actuation and said maximum actuation based on an amount of pressure applied to said mechanical trigger.

6. The electric hair cutting device of claim 5, wherein said mechanical trigger comprises a force resistive sensor, and wherein said force resistive sensor is disposed in a voltage divider circuit, such that said actuation signal corresponds to an output voltage from said force resistance sensor.

7. The electric hair cutting device of claim 5, wherein said mechanical trigger comprises a push button connected to a pressure sensor, such that said actuation signal corresponds to a pressure value applied to said push button.

8. The electric hair cutting device of claim 1, wherein said trigger is an optical sensor which is actuated between said minimum actuation and said maximum actuation by adjusting an amount of light received by said optical sensor.

9. The electric hair cutting device of claim 1, wherein said trigger is disposed on a back face of said housing in a location proximate to an index finger of a user of said electric hair cutting device.

10. The electric hair cutting device of claim 1, further comprising a lock which causes said trigger to remain in a particular actuation between said minimum actuation and said maximum actuation.

11. The electric hair cutting device of claim 1, further comprising a safety which prevents actuation of said trigger.

12. A charging stand, comprising:
a casing with a top surface having a charging port for charging an electric hair cutting device, and a front surface with a digital display; and
a control module within said casing which is connected to said digital display and which includes a wireless communication interface, such that said control module receives control signals from the electric hair cutting device and said control module causes said digital display to display, in real-time, an operational parameter of the electric hair cutting device received by said wireless communication interface, wherein said digital display displays at least one wallpaper from a plurality of wallpapers, and wherein said at least one wallpaper includes said operational parameter.

13. A charging stand for an electric hair cutting device, comprising:
a casing with a top surface having a charging port for the electric hair cutting device, and a front surface with a digital display; and
a control module within said casing which is connected to said digital display and which includes a wireless communication interface, such that said wireless communication interface receives control signals from the electric hair cutting device and said control module causes said display screen to display, in real-time, an operational parameter of the electric hair cutting device received by said wireless communication interface.

14. The charging stand according to claim 13, wherein said operational parameter of the electric hair cutting device is a rotational speed of an electric motor housed within the electric hair cutting device.

15. The charging stand according to claim 13, wherein said charging port includes an insert which is removably secured within said top surface.

16. The charging stand according to claim 13, and wherein said digital display includes a settings page with buttons which direct said digital display to a plurality of subpages.

17. The charging stand according to claim 16, wherein said buttons of said settings page include an LED light changing page which allows adjustment of a color displayed by a string of LED lights disposed on said casing.

18. The charging stand according to claim 16, wherein said wireless communication interface is a Bluetooth receiver, wherein the electric hair cutting device is Bluetooth compatible, and wherein said buttons of said settings page include a Bluetooth pairing page which is configured to providing pairing of the electric hair cutting device to said charging stand.

19. The charging stand according to claim 13, wherein said casing includes an auxiliary charging port configured for charging a separate electronic device.

20. The charging stand according to claim 13, wherein said digital display displays at least one wallpaper from a plurality of wallpapers, and wherein said at least one wallpaper includes said operational parameter.
